(19) United States
(12) Patent Application Publication
(10) Pub. No.: US 2011/0191425 A1
(43) Pub. Date: Aug. 4, 2011

(54) Geospatially Aware Message System and Method

(75) Inventors: Patrick Brodeur, Gatineau (CA); Edward Funnekotter, Ottawa (CA); Jason Whelan, Ottawa (CA); Rlchard Dubuc, Kanata (CA); Hans Jespersen, Kitchener (CA); Denis Junior King, Ottawa (CA)

(73) Assignee: SOLACE SYSTEMS, Kanata (CA)

(21) Appl. No.: 12/698,257

(22) Filed: Feb. 2, 2010

(51) Int. Cl. G06F 15/16; H04L 12/56

(52) U.S. Cl. 709/206; 370/401

(57) ABSTRACT

Publishers inject messages containing geospatial data into a content routed network. The subscribers pre-register geospatial data defining an arbitrary geographic region of interest with their subscriptions. The messages are delivered to interested subscribers based on a comparison of the content data and the geospatial data contained in the messages with the corresponding data associated with said pre-registered subscriptions.

### FIELD OF THE INVENTION

This invention relates to data communication networks and in particular to a method of message delivery based on geospatial information.

### BACKGROUND OF THE INVENTION

In the prior art, many message delivery systems exist which offer message delivery between endpoints, such as between different applications. The message delivery systems may implement different network topologies such as point to point or publish/subscribe and different service types such as assured (also know as guaranteed or persistent) and reliable (also known as best effort).

Such messaging systems provide for loosely coupled message delivery between the message source and the receiving application (for one-to-one delivery) or receiving applications (for one-to-many delivery). The mechanism by which the messaging system determines how to route a particular message to its destination endpoint(s) is another form of differentiation between messaging systems know in the art. Prior art messaging systems use topics (metadata tags added by the message source) or inspection of the message content itself to determine which endpoint(s) to deliver a particular message to. The endpoints may be different applications or a queue that could be shared by multiple applications or a combination of applications and queues. The criteria used by the message delivery system to determine which messages to deliver to which endpoint(s) may be configured by the administrator of the system or the endpoint(s) themselves can indicate their own interests in the form of subscription requests.

Some application endpoints may be interested not only in messages related to a particular topic or type of content but, also to messages that relate to a particular geospatial area.

Message delivery systems that are capable of delivering messages based on a geographic area related to the message typically restrict delivery to specific named areas and the area name essentially becomes the topic or an extension of the topic. Examples of such area names are the ZIP code or a telephone area code. New XML standards such as the EDXL standard created by the Organization for the Advancement of Structured Information Standards (OASIS) are capable of carrying location data not only based on named locations (such as countries) but also based on circles or arbitrary polygons. Existing message delivery systems are not capable of delivering messages based on geospatial location data consisting of arbitrary areas because their matching criteria are based on string matching (regular expressions or wildcards) or simple predicates with which there is no way to determine if the arbitrary area contained in the message or topic falls within another or overlaps with an arbitrary area of interest to a particular endpoint. It is highly desirable in these applications to have a message delivery system that is capable of routing messages not only based on topic (or content) but based on the intersection of arbitrary geospatial areas.

### SUMMARY OF THE INVENTION

According to the present invention there is provided a method a method of routing messages in a content routed network wherein the messages are published into the network by publishers and routed to interested subscribers in accordance with their topic or content based on pre-registered subscriptions, comprising associating geospatial data with said subscriptions, said geospatial data defining by geographic coordinates an arbitrary geographic region of interest to a corresponding subscriber; inserting geospatial data into messages published into the network; extracting topic or content data from the published messages; extracting the geospatial data from at least a subset of said published messages; comparing the topic or content data of said published messages with the pre-registered subscriptions; comparing the geospatial data extracted from the published messages with the geospatial data associated with said subscriptions; and delivering said messages to the interested subscribers based on the comparison of the extracted topic or content data and the extracted geospatial data with the corresponding data associated with said pre-registered subscriptions.

The region of interest may be defined, for example, by a polygon, with the geographic coordinates representing the points of the polygon. Alternatively, other definable shapes, such as circles, could be used.

It will be appreciated that any suitable coordinate system may be employed to represent points on the earth's surface or even in a three dimensional space. For example, a user might be interested in weather information within a certain altitude range over a defined geographic area, or alternatively may wish to exclude information over a certain area. The geospatial comparison can be performed together with the content matching or as a separate function. In this context, matching refers to the comparison of the data with the subscriptions to identify interested subscribers. It will be appreciated that the messages can be delivered to subscribers for which only a partial match is found, or in some cases, it may be desirable to use inverted logic wherein messages are delivered to subscribers for which there is no match. For example, in the case of geospatial information, a subscriber may be interested in excluding messages pertaining to a particular geographic area which is of no interest.

The geospatial matching can be performed as part of the content matching operation so that messages are routed through the network on the basis of both content and geospatial matching, or in an alternative embodiment it can be performed as a filtering operation at an egress router. In this case, the messages are routed through the network in the same way as in a conventional content routed network, and then filtered prior to delivery to the subscribers connected to the egress router. As noted, they can be filtered using either normal or inverted logic, i.e. delivery in the case of the absence of a match, or in accordance with a partial match, for example, using a wild card.

It will be appreciated by persons skilled in the art that the routing can be performed either on the topic associated with the messages or their content.

In another aspect the invention provides a content routed network wherein the messages are published into the network by publishers and routed to interested subscribers in accordance with their topic or content based on pre-registered subscriptions, comprising: at least one router for distributing incoming messages to subscribers; a memory for storing geospatial data in association with said subscriptions, said geospatial data defining an arbitrary geographic region of interest to a corresponding subscriber by geographic coordinates; a subscription matching engine for comparing the topic or content data of said published messages with the pre-registered subscriptions; a geospatial data processing unit for comparing the geospatial data from the published messages with the geospatial data associated with said subscriptions; and wherein said at least one router is configured to deliver said messages to the interested subscribers based on the comparison of the extracted topic or content data and the extracted geospatial data with the corresponding data associated with said subscriptions.

In yet another aspect the invention provides a router for use in a content routed network wherein messages are published into the network by publishers and routed to interested subscribers in accordance with their topic or content based on pre-registered subscriptions, comprising: a memory for storing geospatial data defining an arbitrary geographic region of interest to a corresponding subscriber by geographic coordinates, said geospatial data being associated with the corresponding subscriptions; a subscription matching engine for comparing topic or content data extracted from incoming messages with topic or content data associated with the subscriptions; a geospatial matching engine for comparing geospatial data contained in incoming messages with geospatial data associated with pre-registered subscriptions; and wherein said router is configured to forward said incoming messages based on the comparison of the extracted topic or content data and the extracted geospatial data with the corresponding data associated with said pre-registered subscriptions.

### BRIEF DESCRIPTION OF THE DRAWINGS

The invention will now be described in more detail, by way of example only, with reference to the accompanying drawings, in which:—

FIG. 1 shows an example message network providing assured message delivery service;

FIG. 2 shows a block diagram of a device that may be used in this invention;

FIG. 3 shows the processing logic for handling a subscription request containing geospatial areas from a client;

FIG. 4 shows the processing logic for routing a message using geospatial areas;

FIG. 5 shows some sample XML message content that contains geospatial areas;

FIG. 6 shows an XPATH function for matching geospatial areas; and

FIG. 7 show a more specific example of an XPATH function for matching geospatial areas.

### DETAILED DESCRIPTION OF THE PREFERRED EMBODIMENTS

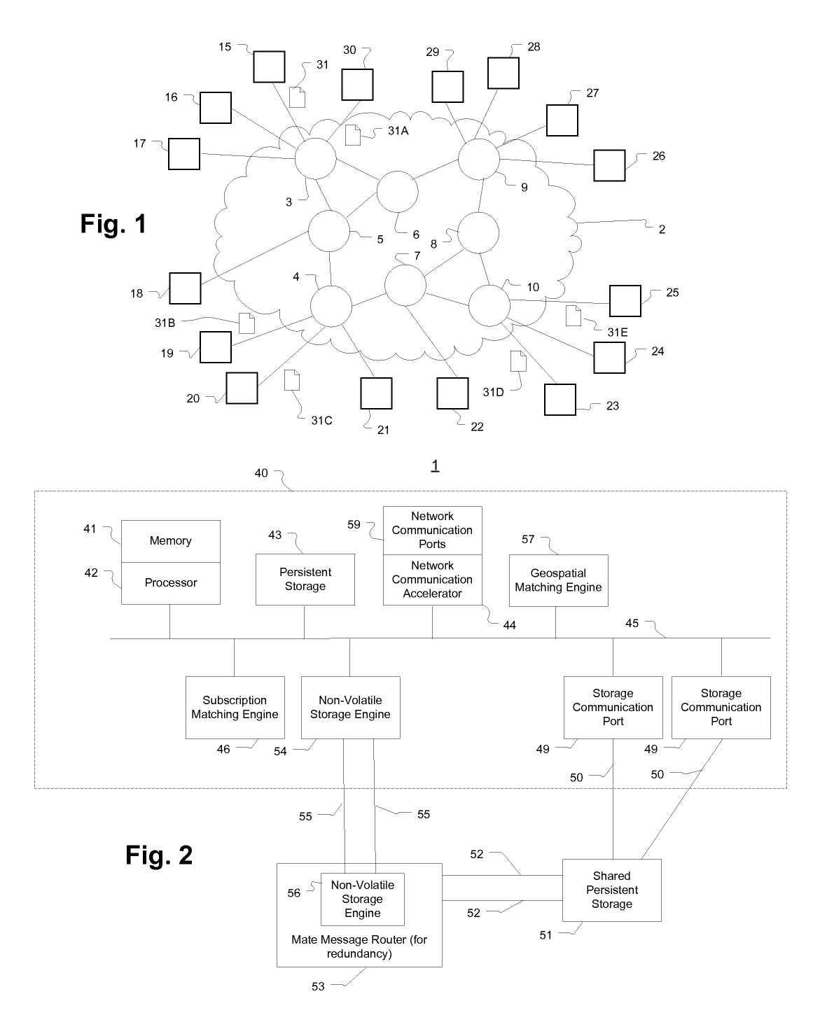

FIG. 1 shows an example system 1 which consists of a message delivery network 2 which is providing a scaleable, distributed message delivery service capable of routing messages based on geospatial areas, as well as clients for the service. Network 2 consists of message delivery routers 3 through 10 which can be flexibly deployed as a single instance or in various different network topologies, with an example topology shown in FIG. 1. An example of a device which can serve as a router 3 through 10 is the 3200 Series of Content Routers from Solace Systems, Inc. Note that routers 3 through 10 may be deployed as an overlay to an underlying IP network. Connected to network 2 is a plurality of messaging applications or clients 15 through 30, which may be any type of device or software which wishes to send and receive messages, with the message delivery to one or more recipients being based at least in part on geospatial information. Note that while only a small number of clients are shown, such a delivery network can support a large number of clients, such as millions, and can scale to a large number of message routers.

Clients 15 through 30 may produce (or publish) messages to be distributed by the message delivery network 2 or may register interests (or subscriptions) with the network 2 if they wish to consume (or subscribe to) messages or may choose to both produce and consume messages. If the clients 15 through 30 wish to consume messages they must register their preferences as to which types of messages they would like to receive by entering subscription request(s). For example client 15 is connected to message delivery router 3; if client 15 would like to receive messages from the messages delivery network 2 then it must make a subscription request to its subtending router 3. Alternatively, router 3 can be provisioned through a management interface with the message preferences (subscriptions) on behalf of a client such as client 15. Upon receiving the subscription request message router 3 must transmit this information to the other message routers 4 through 10 that make up the message routing network 2; this is so that when a message matching the criteria contained within the subscription request entered by client 15 is received by a router 3 through 10 from one of the clients 15 through 30 the routers 3 through 10 will know which clients 15 through 30 to send the message to. Note that in general the message delivery network 2 consists of multiple message delivery routers but, could also consist of a single router. The subscription request could be an XPATH expression if the client 15 is interested in receiving specific types of XML data or it could be an expression in a more complicated query language such as XQUERY. If the data is non XML then it is possible to use other standard query languages such as SQL, UNIX regular expressions or proprietary as they are know in the art; independent of or in addition to these expressions the subscription requests could contain arbitrary geospatial areas that could be used to route or filter messages for delivery to a client 15 through 30. Geospatial criteria could be used as an alternate subscription request mechanism or could be used to augment other subscription request languages previously mentioned. An arbitrary geospatial area could be a circle defined by its center position and a radius or a polygon represented as a list of co-ordinates; the areas could also carry height information to form a three dimensional area or sets of co-ordinates containing longitude, latitude; co-ordinates could be augmented to also contain altitude and used to define any arbitrary three dimensional space. The message routing network 2 can compare geospatial areas contained in subscription requests obtained from its clients 15 through 30 to geospatial areas contained in messages produced by other clients 15 through 30; based on whether or not these areas intersect, the message routing network 2 can make decisions about which clients 15 through 30 should receive a particular message.

In the prior art mechanism of routing of messages, with the routing of messages based on named areas such as cities, states, countries, zip codes, etc., the publisher of the messages is pre-labeling the message with a named geographic entity, and the subscribers are limited to subscribing to messages based on these named entities. With geospatial routing based on areas such as a polygon, a message publisher can publish a complex area that the message pertains to, such as the area of coverage of a sensor, where the message contains the area covered and the sensor data being reported. Each subscriber can subscribe to areas of interest, which do not have to exactly correspond to the areas in the messages being published. For example, a subscriber may subscribe to an area which is partially covered by a number of publishing sensors. This is not possible with the much less flexible use of named areas.

FIG. 1 also shows an example of a message 31 being submitted by client 15. This example message results in a copy 31A being delivered to client 30, a copy 31B being delivered to client 19, a copy 31C being delivered to client 20, a copy 31D being delivered to client 23, and a copy 31E being delivered to client 25.

The message 31 can be routed to the set of interested destinations or queues based on topics or routed based on the content of the message using content routing techniques. In addition to topic or content the messages could be routed based on geospatial areas contained within the content of the message or as supplemental information to the topic. Alternately the messages could be routed through network 2 based on topic or content and then filtered based on geospatial areas at the final router 3 through 10 before delivery to the client 15 through 30. An example of a method for content routing of messages is detailed in U.S. application Ser. No. 11/012,113, the contents of which are incorporated herein by reference. As a short summary of the routing method detailed in this reference, the inbound router 3 of FIG. 1, upon receiving message 31, determines the set of local clients interested in the message (client 30), as well as the set of remote message routers interested in the message (4 and 10). The set of destination clients that wish to receive the message is determined by examining the message topic or content and comparing this information with interests or subscriptions that clients 15 through 30 have injected into the network 2. When the message is sent onwards to message routers 4 and 10, a shared copy of the message may be forwarded upon common routes. In the example of network 2, the preferential route to routers 4 and 10 from router 3 is via router 5, so a single copy of message 31 is sent towards router 5, indicating a destination list of router 4 and 10. Router 5, upon receiving the message, sees that it is not in the destination list for the message, and so simply forwards the message onwards towards routers 4 and 10, with the route to both being via the link to router 4. Upon receiving the message, router 4 can immediately forward the message onwards to router 10 (via router 7), after removing itself from the destination list, and then, since router 4 appears in the destination list, router 4 can process the message for delivery to interested local clients (19 and 20). In this example implementation router 4 must perform a secondary matching of topics or content in order to determine that locally attached clients are interested in receiving the message. Router 7 simply forwards the message onwards to router 10 since it is not in the destination list. Router 10 processes the message since it is in the destination list, and will send the message to interested clients 23 and 25. Note that in another implementation it is possible for router 3 to perform topic, content or geospatial matching for all clients connected to network 2; however this implementation is less scalable because every router 3 through 10 needs to maintain information about every client 15 through 30.

The present invention is related to the system described in the previous example however the techniques used to route messages from publishing clients to subscribing clients are augmented to include geospatial areas in message topics or content as well as the subscriptions. In the previous example the message 31 must have its content or topic inspected by the router 3 that initially received the message 31 from the client 15. Every message router 3 through 10 which has attached clients that have expressed interest based on subscription requests to receive messages that match certain criteria present in message 31 must also inspect the message content or topic to determine which of its attached clients to forward the message to. In this specific example the subset of routers 3 through 10 that have clients 15 through 30 with subscriptions matching the message 31 is routers 3, 4 and 10. These routers 3, 4 and 10 must match the topic or content to the set of subscriptions that they have received from their clients 15 through 30 as well as matching any geospatial areas included in the message or topics to any subscriptions they have received that contain geospatial areas. Optionally the geospatial areas can be applied as filters on terminating or egress routers in which case only the routers 3 through 10 that have locally attached clients 15 through 30 that have entered subscriptions for a particular type of content or related to a particular topic will have their geospatial areas examined and only at destination routers (in this example routers 3, 4 and 10). In this case the destination routers 3, 4 and 10 will compare geospatial areas contained within message 31 with geospatial areas contained in filters submitted by locally attached clients that have registered subscriptions for the topic or content of message 31 (in this example clients 30, 23, 25, 19 and 20). If the geospatial areas contained within the filters submitted by the clients intersect geospatial areas contained within the message then the message will be delivered; if the geospatial areas do not intersect then the message will be discarded (or filtered). Alternately the filter could use inverted logic such that if the geospatial areas contained within the message do not intersect with the geospatial areas contained in the filters then the message will be delivered. Other geospatial matching semantics are also possible such as matches exactly or is completely contained within or other. The difference between a subscription request entered by a client 15 through 30 and a filter is that the filters are not propagated to the other routers 3 through 10 that make up the message delivery network 2; filters are only applied at routers 3 through 10 that have locally connected clients 15 through 30 with subscriptions matching the topic or content of the messages.

It should be noted that in addition to the distributed message delivery system 1 shown in FIG. 1, a hub-and-spoke model can also be utilized where the clients are all connected to a single router (or a pair of routers for redundancy). Also note that multiple service classes such as assured or reliable delivery can be utilized in the example described above, without affecting the applicability of this invention.

FIG. 2 shows a block diagram of an exemplary device 40 (representing a device such as an individual message router from the set of 3 through 10) of the present invention, which includes a (or many) central processing unit (CPU) 42, also called a processor, with associated memory 41, persistent storage 43, a plurality of network communication ports 59. The network communication ports 59 may perform only basic input/output functions, leaving the protocol processing to CPU 42, or may have an associated network communication accelerator 44 consisting of a specialized processor(s) such as a network processor or other hardware devices to do protocol processing (such as IP processing, UDP or TCP processing, HTTP processing, proprietary protocol processing, etc). Subscription matching engine(s) 46 are used to match message topics or contents to subscription requests entered by clients for specific types of messages. An example of a subscription matching engine 46 is detailed in U.S. application Ser. No. 11/224,045, the contents of which are incorporated herein by reference. Messages that contain geospatial areas in their contents or topics are matched to subscriptions that also contain geospatial areas by the geospatial matching engine 57 or by the processor 42 if a discrete geospatial matching engine 57 is not present in the system. The persistent storage 43 is used to hold configuration data for the router, event logs and programs for the processor 42 and optionally to hold state required for assured message delivery. The persistent storage 43 may be redundant hard disks, solid state disks or other similar devices. The network communication ports 59 are the ports which the router uses to communicate with other devices, such as other routers and hosts (messaging clients). Many different technologies can be used, such as Ethernet, Token Ring, SONET, etc. The communications bus 45 allows the various router components to communicate with one another, and may be a PCI bus (with associated bridging devices) or other inter-device communication technologies known in the art, such as a switching fabric. Communications bus 45 may also be redundant.

For an example application of content or topic routing, the processor 42 is responsible for tasks such as running content routing protocols XLSP and XSMP (as per U.S. application Ser. No. 11/012,113), computing routing tables and performing other control and management functions. The processor 42 may also be performing protocol processing and message extraction functions if the system does not contain a network communication accelerator 44 or may be assisting a network communication accelerator 44 in performing these functions. The network communication ports 59 and network communication accelerator 44 are responsible for communication with external clients for the purpose of processing received documents or messages and routing them based on content or topic possibly with the help of the processor 42. A subscription matching engine 46 may be used to assist with the onerous task of matching message content or topics to subscription requests entered by clients; the geospatial matching engine 57 provides a similar function to the subscription matching engine 46 but operates on geospatial areas rather than topics or message content. The system may choose to carryout out the logic to ensure assured message delivery depending on the service level requested by the client applications. In order to provide assured delivery with high rate and low latency as described in U.S. patent application Ser. No. 11/781,607 the contents of which are incorporated herein by reference, the following system components may also be required; a non-volatile storage engine 54, shared persistent storage 51 (or persistent storage 43 may optionally be used) and an optional redundant router 53 with a non-volatile storage engine 56 if a high availability service is required. In the case of assured delivery, a storage communication port 49 (or multiple for redundancy), utilizing technology such as Fiber Channel, SCSI, Ethernet, SAS, etc. is used to connect to shared persistent storage 51. An external, shared persistent storage 51, connected over link 50 (or multiple for redundancy), can be used to store shared state, such as assured messages and their state information. Storage 51 is connected to one or more other mate message routers 53 (e.g. via link(s) 52), and thus if a message router completely fails, the shared storage 51, and the assured messages and state stored on it, are not affected.

Mate message router 53 preferentially has the same blocks as message router 40, but these details other than the mate's non-volatile storage engine 56 are not shown in FIG. 2. Non-volatile storage engine 54 is used for shorter-duration persistent storage of assured delivery messages and their associated state. It provides consistent low-latency and high throughput storage. Non-volatile storage engine 54 is connected, preferentially through redundant links 55, to the mate non-volatile storage engine 56 in the mate message router 53. This allows automatic replication of assured delivery messages and associated state between the interconnected non-volatile storage engines 54 and 56. The present invention deals with a messaging system consisting of message routers an example of which is show in FIG. 2 that are capable of delivering messages not only based on topic or content but also based on geospatial information. In this case clients submit subscription requests that contain references to geospatial areas of interest as well as the normal topic or content subscription matching rules. Similarly the messages themselves contain information about geospatial areas relevant to the message either as a part of the topic (or metadata to the topic) or in the message content itself. The geospatial areas can be in the form of a circle represented by a center co-ordinate and a radius or a list of co-ordinates representing an arbitrary polygon or any other method of representing an arbitrary area. The geospatial areas may contain height information or bottom and top altitudes for areas that are three dimensional; optionally the co-ordinates could be extended to contain altitude so that an arbitrary surface could be represented.

Subscription requests entered by clients are gathered by the processor 42 (possibly with help from the network communication accelerator 44) and distributed to subscription matching engine(s) 46 and geospatial matching engine(s) 57. These matching engines 46 and 57 may be implemented in the processor 42 or the network communication accelerator 44 but, for performance reasons are likely implemented in discrete hardware devices (or co-processors) connected to the system bus 45. A discrete geospatial matching engine 57 could be implemented using field programmable gate arrays (FPGAs), application specific integrated circuits (ASICs), graphics processing unit (GPU), cell processors, or other processing technology. Information from the subscription requests related to topics or content will be distributed to subscription matching engine(s) 46 and information related to geospatial areas will be distributed to the geospatial matching engine 57. Note also that the subscription matching engine 46 and the geospatial matching engine 57 could also be integrated as functions within the same device for efficiency. When a message is received by the message router via the network communication ports 59 the network communication accelerator 44 will transfer the relevant topics and contents to the subscription matching engine(s) 46 and any geospatial data to the geospatial matching engine 57. These engines 46 and 57 will process the data; comparing it to the set of subscriptions that they are storing and return indications to the processor 42 (or the network communication accelerator 44 depending on the implementation) of which subscriptions or geospatial areas matched. In the case of a geospatial area a match response is triggered base on the detection of a particular relationship between areas contained in the message and areas that have been received in subscription requests; the nature of the relationships that the geospatial matching engine 57 endeavors to detect are detailed in the subscription request. Those skilled in the art of linear algebra will see that there are many other possible relationships between areas that could be used to define a match, such as areas overlap (or intersect), areas match exactly, areas do not overlap, area is contained within or some other relationship are all within the scope of the present invention.

It should be noted that instead of using two physically separate message routers 40 and 53 as shown in FIG. 2, redundancy can also be provided in an integrated system through hot-swappable cards in a chassis. For example, the message router can utilize redundant components such as redundant processing cards 42 with associated memory 41, redundant network communication ports 59 and network communication accelerators 44, redundant subscription matching engines 46, redundant geospatial matching engines, redundant non-volatile storage engines 54 and 56, etc. Interconnect 45 itself can be a redundant interconnection fabric. Links 55 can optionally be done via the redundant interconnection fabric 45, or via dedicated interconnection lines on the system backplane. It will be understood that any discussion of a message router and a mate message router for the purposes of redundancy can also refer to redundancy provided through an integrated message router with redundant components. Shared persistent storage 51 can also be integrated into the same chassis, communicating with the rest of the system over the redundant interconnect fabric 45 or other dedicated communication channels provided on the system backplane, or be kept as an external device. It should also be noted that all components in FIG. 2 could be functional blocks within a software process, all executing on a typical general purpose CPU and communicating via message passing as is well known in the art.

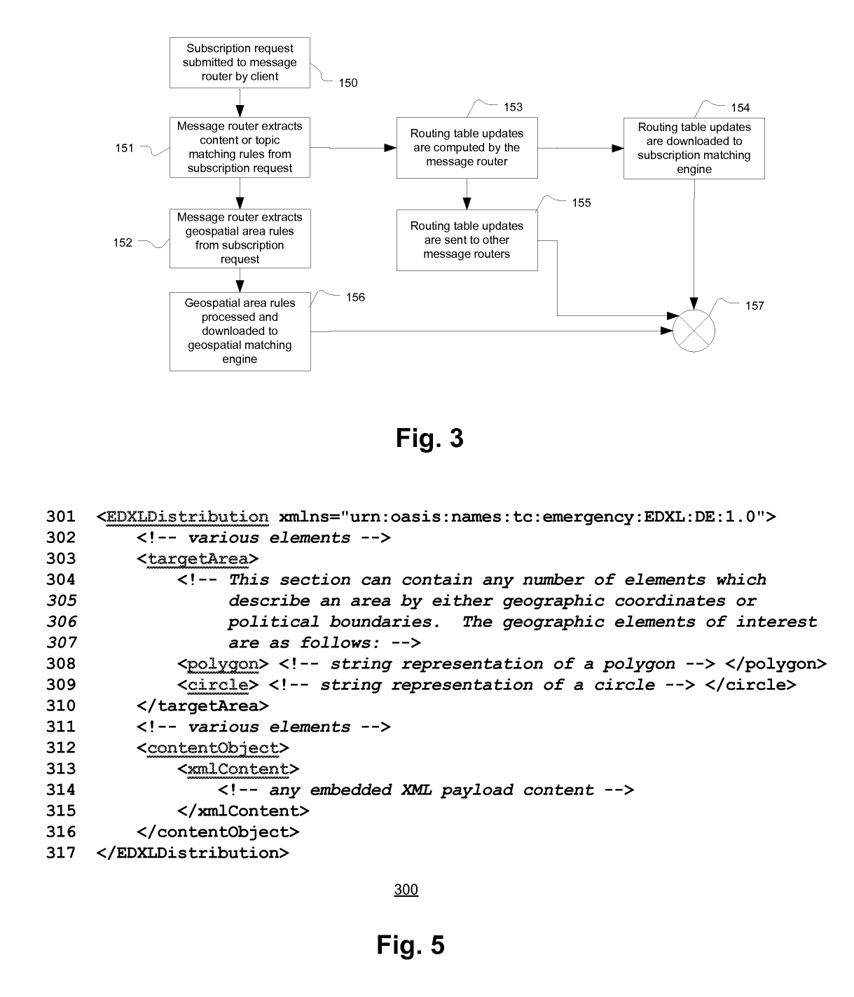

The processing that a message router 40 must perform when a subscription request is received from a client is depicted in FIG. 3. The message router 40 receives a subscription request from a client in step 150. The message router 40 must parse the request and extract the parts referring to topic or content subscriptions in step 151. The topic or content subscriptions are used to compute a set of routing table updates in step 153. The routing table updates are required in two subsequent steps 154 and 155. In step 155 the routing table updates are distributed to other message routers in the network using content routing protocols such as XLSP and XSMP as previously discussed. Step 154 is where the updates to the route table are downloaded to the subscription matching engines. The format of the route table updates used in steps 154 and 155 may be very different; in step 155 the updates need to be transferred across the network and so the emphasis is likely to be on a format that makes efficient use of network bandwidth, in step 154 the updates need to be in a format that allows the subscription matching engine 46 to efficiently match the incoming messages to subscriptions. In step 152 the message router 40 must extract any geospatial areas from the subscription request and format them before downloading them to the geospatial matching engine 57 in Step 156. In step 156, similar to step 154; the geospatial areas must be converted to a format that will allow the geospatial matching engine 57 to efficiently detect particular types of relationships between the geospatial areas contained in subscription requests and geospatial areas contained in the content or topics of messages sent to the message router 40 by its clients. Note that in place of a client submitting subscription requests in step 150, the subscription requests on behalf of a given client can be submitted to the router via a management interface; the rest of the logic is not affected.

An alternate method of processing subscription requests is to distribute information related to geospatial areas contained in subscriptions to all message routers 3 through 10 in the content routing network 2 as is done with the topic and content portions of the subscription requests. In the previously described method, the matching of geospatial areas is only done on message routers 3 through 10 that have locally attached clients that have matching topic or content subscriptions for a particular message. In this case the geospatial area portion of the subscription is applied as a filter to prevent messages related to certain areas from being delivered to a particular client. The geospatial matching is a relatively expensive procedure in terms of processing and so is only performed once in the network at the terminating message router 3 through 10. If network bandwidth was the critical resource then the alternate implementation would be optimal where geospatial areas are distributed to all message routers 3 through 10 via the routing protocols so that messages sent from clients that have no matching subscription requests (including appropriate geospatial areas) could be discarded by the ingress router before they are sent to other routers 3 through 10 in the network 2. This saves bandwidth consumed by sending messages to routers 3 through 10 that have clients interested in the message based on examination of the topic or content but are later found not to be interested in receiving the message at the terminating node because of the client's requirement for messages related only to a particular geospatial area.

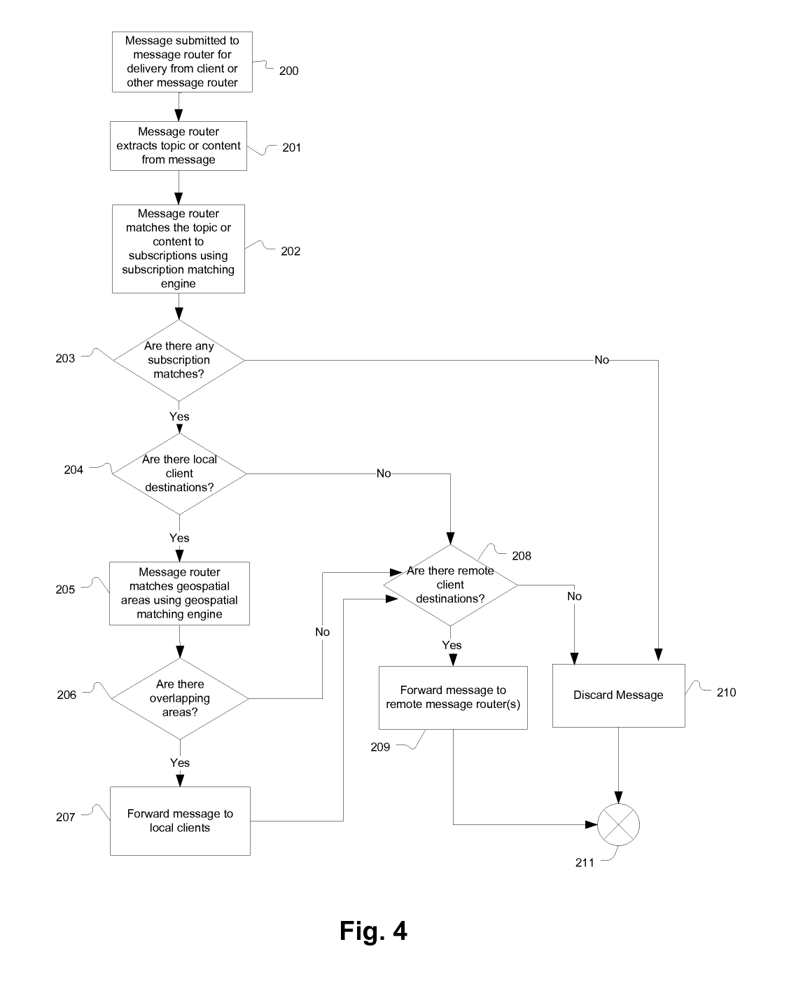

FIG. 4 shows the processing steps that a message router 40 must perform upon receiving a message from a client or another message router 3 through 10. In this example it is assumed that the message router 40 is a terminating node as such it has at least one locally connected client that has indicated an interest in receiving messages related to the topic or content of the present message. In step 200 a message is received by the message router 40; the message is parsed and the topic or content to be matched is extracted at step 201. The topic or content extracted from the message is transferred to the subscription matching engine 46 at step 202. After processing of the topic or content has been completed by the subscription matching engine 46 the results are tested at step 203 to see if there are any clients connected to the message routing network 2 that have issued a subscription request that matches the present message. It is assumed for this example that the matching engine 46 has returned matches and more specifically matches for locally attached clients however if there are no clients connected to the message router 40 that have issued a subscription request that matches the topic or content of the message then the message will be discarded by the message router 40 at step 210. The results from the matching engine 46 are checked to see if they are for locally attached clients at step 204; it is possible that the subscription matching engine 46 could return multiple matches for a combination of locally attached and remotely attached clients and each match must be individually processed. The matches returned by the subscription matching engine 46 for locally attached clients are processed first (although the order is not significant) at step 205. For matches returned for locally attached clients any geospatial areas contained within the message content or topic will be transferred to the geospatial matching engine 57. These geospatial areas will be compared to geospatial areas entered by clients in the form of subscription requests by the geospatial matching engine 57 to identify any matching relationships between the areas (such as an area of intersection). U.S. Pat. No. 6,917,877 the contents of which are incorporated herein by reference contains an example of methods that can be used to determine intersections of overlapping geospatial areas described by polygons; other examples of techniques that can be used to determine relationships between arbitrary areas are contained in O'Rourke, Joseph “Computational Geometry in C, Second Edition”, Cambridge University Press, 1998. If geospatial areas associated with the topic or content subscriptions that have already been matched by the subscription matching engine are found to have a matching relationship with geospatial areas contained within the message or topic then the geospatial matching engine 57 will indicate a match or series of matches (if more than one matching relationship is detected). The algorithms employed to detect matching relationships between geospatial areas are computationally intensive and in some circumstances performing some preprocessing to remove geospatial areas entered in subscription requests that obviously do not have a matching relationship from the set of areas that are compared by the geospatial matching engine 57 may improve system performance; this is an optional step and is not shown in FIG. 4. Another possible optimization is to have the subscription matching engine 46 return a reference to lists of geospatial areas that have been associated with subscription requests that have already triggered topic or content matches in the subscription matching engine 46. This will further reduce the number of geospatial areas that must be compared or checked for a particular message by the geospatial matching engine 57 helping to further increase performance. If the geospatial matching engine 57 detects a relationship between areas associated with a topic or content subscription request that has been matched by the subscription matching engine and an area associated with the message topic or content at step 206 then the message will be forwarded to the clients for which matches were detected in step 207. Once the processing of topic or content matches for locally attached clients has been complete (by performing geospatial matching and delivering messages to clients meeting the matching criteria) then processing of topic or content matches for clients attached to remote message routers 3 through 10 is performed. Step 208 tests for the existence of content or topic matches for clients attached to remote routers 3 through 10; if such matches were detected in step 202 then copies of the message will be forwarded to those routers 3 through 10 for which matches were detected at step 209. If no matches for clients connected to remote routers 3 through 10 were detected in step 202 then no further processing is performed on the message and it is discarded at step 210.

In the previous example the geospatial areas are compared only at terminating nodes of the content routing network 2; as such they are often called filters because they serve to filter off (discard) messages before they are delivered to clients. An alternate method is to distribute the geospatial area information gathered along with the subscription requests to all nodes 3 through 10 in the content routing network 2 using content routing protocols as previously discussed. This would allow messages that have no destination clients (based on all routing criteria, content, topic or geospatial) to be discarded by the ingress node (the node that initially received the message from a client 15 through 30). This implementation optimizes network bandwidth because it reduces the probability that a message will be forwarded on to a remote terminating node 3 through 10 only to be discarded by the terminating node before delivery to the client 15 through 30 because of a failure to match geospatial criteria.

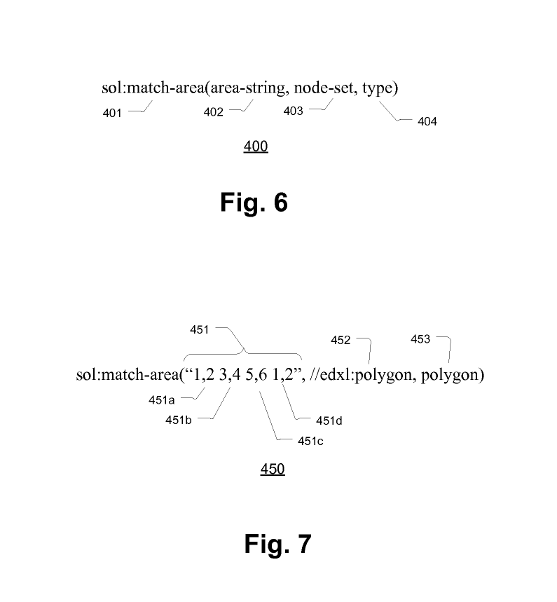

In order to enable clients to make subscription requests that incorporate geospatial areas some enhancements must be made to the mechanisms that are commonly used in content or topic routing applications by clients 15 through 30 to enter subscription requests into the network 2. For example in a content routing application where the content of the messages is XML it is common for clients to use a standard language such as XPATH or XQUERY in their subscription requests. XPATH is a language standardized by the World Wide Web Consortium (W3C) that is used to address parts of an XML message; it can be used in content routing applications as a subscription language. In this example clients 15 through 30 have entered subscription requests into the content routing network 2 in the form of XPATH expressions and the individual content routers 3 through 10 will compare these XPATH expressions to incoming XML messages that they are receiving from their publishing clients 15 through 30; possibly with the help of a subscription matching engine 46. If a XPATH expression evaluates to anything other than false for a particular XML message then a match is generated by the subscription matching engine 46. Currently the XPATH language contains no mechanism to evaluate geospatial areas other than a string match (there is no way to detect any relationship between two geospatial areas other than they are described by exactly the same string). In order to do this, a new XPATH function in addition to the ones defined in the XPATH standard could be defined such the sol:match-area function 400 shown in FIG. 6. In this example, the name of the function 400 is sol:match-area, where “sol” is a namespace prefix to make the function name “match-area” globally unique, and the “sol” prefix maps to a unique namespace name such as“www.solacesystems.com”, as per the XML namespace specification.

In this case the first argument to the sol:match-area( )function 400, area-string 402 is a string that describes the subscriber's desired geospatial area. The area could be a series of longitude and latitude co-ordinates that define a polygon if it is a polygon area that is to be matched; it could be a longitude and latitude co-ordinate plus a radius if the area to be matched is a circle. The area could also be three-dimensional to describe an arbitrary three-dimensional shape. The second argument to the sol:match-area( )function 400, node-set 403 is a reference to a particular range of XML nodes within the XML messages that contain the geospatial area strings. The type argument 404 tells the sol:match-area( ) function 400 how to interpret area-string 402; as previously stated if the area is a polygon then the area string will be a list of co-ordinates identifying the vertices and if the area is a circle then the area-string will be a center co-ordinate and a radius. Note that there is an area-string contained in the first argument 402 of the sol:match-area( )function 400 as well as a series of area-strings that may be extracted from incoming XML messages. In the case of the sol:match-area( )function 400, all these areas must be of the same type. It is possible to define other functions that are capable of matching different types of areas to each other; for example polygons to circles etc. within the scope of the present invention. Other types of geospatial areas beyond polygons and circles are also possible and within the scope of the present invention; for example three dimensional areas could be defined by adding a height to the polygons or circles or more general three dimensional surfaces could be defined.

FIG. 5 shows some sample XML that illustrates the structure of a message 300 created in accordance with the EDXL-DE schema standardized by the OASIS Consortium. The EDXL-DE schema is an example of a XML schema that makes use of geospatial areas and is compatible with the proposed sol:match-area( )function 400. If a client 15 through 30 wanted to enter a subscription request with a polygon component the sol:match-area( ) function 400 could be used as function 450 of FIG. 7 (embedded within a more complex XPATH expression the method of which is well-known in the art).

In this example 450, the polygon is a triangle defined by co-ordinates 451, with vertices (1,2) 451a, (3,4) 451b and (5,6) 451c. The final (1,2) 451d co-ordinate is redundant but required by the EDXL specification to explicitly close the polygon. The “//edxl:polygon” 452 argument (the second argument to the sol:match-area( )function 400) is to indicate that the function should look in any element of incoming messages named <polygon> within the namespace identified by edxl (for example line 308 of FIG. 5) for a sting containing a list of co-ordinates that define a polygon. The third argument of the sol:match-area( )function 400 is a type that tells the function how to interpret the strings that it extracts from the XML message; in this case the type is a polygon 435 and the function should treat any strings that it extracts from the edxl:polygon elements as a list of co-ordinates forming a polygon. The sol:match-area( )function 450 will evaluate to true if any part of the polygon defined in the first argument 451 overlaps with any part of any polygon found within an element edxl:polygon 452; otherwise it will return false. It is also possible to define other functions similar to sol:match-area( )that will return true if other types of relationships between areas are detected (for example areas exactly overlap instead of partially overlap).

If the sol:match-area( )function 400 was used as a part of a subscription request sent to a message router 3 through 10 by a client 15 through 30 then the content router 40 would evaluate the function as follows. Upon receiving a subscription request from one of its attached clients 15 through 30 the content router 40 will process the XPATH expression and send the relevant parts to its co-processors. In this case the router 40 is an XML content router (which forms a subset of the more general class of devices known as message routers) and has co-processors 46 and 57 for matching XPATH expressions and geospatial areas respectively. When the message router 40 receives a message from a client 15 through 30 it will extract the XML message payload and pass it to the subscription matching engine 46 where all of the XPATH expressions that it has stored as subscription requests will be evaluated against the input message. The subscription matching engine 46 will indicate which of these XPATH expressions evaluate to non zero values (not including the geospatial areas contained in any sol:match-area( )function 400 calls). If the subscription matching engine returned non zero results for an XPATH expression that is part of a subscription request containing a call to the sol:match-area( ) function 400 then the geospatial areas contained within the message at the nodes specified in the second argument 403 to the function call 400 will be passed to the geospatial matching engine 57 to be compared to the area in the subscription request 402. A possible optimization for the case of an XML content router is to have the subscription matching engine 46 also extract the geospatial areas since it has to parse the entire XML message to do the XPATH matching; this will allow the geospatial areas to be efficiently transferred to the geospatial matching engine 57 without the requirement to parse the message a second time to gather the area strings contained at the nodes specified in the node-set argument 403 of the call to sol:match-area( )400. The geospatial matching engine 57 will look for areas of overlap between the areas extracted from the incoming message and the geospatial areas 402 from the subscription request; if any overlapping areas are found then the geospatial matching engine 57 will return a positive match. With both matching engines 46 and 57 returning positive matches for the incoming XML message, the message can be delivered to the client(s) 15 through 30 that entered the matching subscription requests.

Similar to the XML content router application of the previous example, geospatial areas could also be used as matching criteria for a topic routing application. In topic routing applications the messages published by clients 15 through 30 are received by the message routers 3 through 10 with a meta-data topic already applied; it is not necessary for the topic routers 3 through 10 to examine the entire content of the message to determine if it matches a subscription request (as in the previous example of the XML content router). The topic strings are typically a hierarchical concatenation of strings. The subscription requests mimic the topic strings but also allow for prefix matching of strings, wild card matching or other forms of UNIX regular expressions as they are known in the art. The exact format of the topic strings and types of subscription requests (what types of wild card or regular expressions are allowed etc.) vary between implementations but, the basic functionality is similar. The topics and topic subscription requests could be augmented to combine topic routing with geospatial areas by tagging messages that are input to the topic routing network 2 with geospatial areas and by allowing subscription requests to also contain one or more geospatial areas. Similar to the previous XML content routing example clients 15 through 30 send subscription requests to the routers 3 through 10 that make up the topic routing network 2. A topic router 40 upon receiving a subscription request will parse the subscription request and distribute the relevant parts to its co-processors. In this case the content router 40 routes messages based on topic string augmented with geospatial areas and has two coprocessors 46 and 57 to assist with matching messages to subscription requests. The subscription matching engine 46 matches the topic string sent with each input message to topic strings received as a part of the subscription requests; the subscription requests may include some form of wildcard matching which also must be accounted for by the subscription matching engine 46. If the subscription matching engine 46 returns a match for a topic string that was included with a message then the original subscription request that matched the topic string will be checked to see if it included a geospatial component; if it did then the geospatial area(s) included with the message topic string will be sent to the geospatial matching engine 57 for processing. This is similar to the previous example of the XML content router except that the geospatial areas do not need to be extracted from the message content; they are stored in a known location with the topic string. All of the types of geospatial relationships possible in the XML content routing example are also possible in the topic routing example. Areas contained in subscription requests may be polygons or circles that may include height or may be more general three dimensional surfaces. Methods similar to those in the XML content routing example may also be used in the topic routing example to describe geospatial areas such as a list of co-ordinates to describe a polygon or a center co-ordinate and a radius to describe a circle. Similar techniques with respect to what constitutes a matching relationship can also be used such as areas partially overlap, areas exactly overlap, one area is contained within another or areas do not intersect or other. As with the previous XML content routing example the geospatial routing engine 57 will compare the geospatial areas sent with the message topic to geospatial areas that were sent with the subscription requests that were previously matched by the subscription matching engine 46. Messages for which matches were indicated for both the topic (by the subscription matching engine 46) and for geospatial area(s) (by the geospatial routing engine 57) will be delivered to clients 15 through 30 that submitted the matching subscription requests.

It will be appreciated that an exemplary embodiment of the invention has been described, and persons skilled in the art will appreciate that many variants are possible within the scope of the invention.

All references mentioned above are herein incorporated by reference.

We claim:

1. A method of routing messages in a content routed network wherein the messages are published into the network by publishers and routed to interested subscribers in accordance with their topic or content based on pre-registered subscriptions, comprising:
associating geospatial data with said subscriptions, said geospatial data defining by geographic coordinates an arbitrary geographic region of interest to a corresponding subscriber;
inserting geospatial data into messages published into the network;
extracting topic or content data from the published messages;
extracting the geospatial data from at least a subset of said published messages;
comparing the topic or content data of said published messages with the pre-registered subscriptions;
comparing the geospatial data extracted from the published messages with the geospatial data associated with said subscriptions; and
delivering said messages to the interested subscribers based on the comparison of the extracted topic or content data and the extracted geospatial data with the corresponding data associated with said pre-registered subscriptions.

2. A method as claimed in claim 1, wherein the messages are delivered in the event of a match between the extracted topic or content data and the geospatial data with the corresponding data associated with the subscriptions.

3. A method as claimed in claim 1, wherein the messages are delivered in the event of a partial match between the extracted topic or content and the geospatial data with the corresponding data associated with said subscriptions.

4. A method as claimed in claim 1, wherein said geographic data define polygons identifying the geographic regions of interest.

5. A method as claimed in claim 1, wherein the messages are routed through the network based on a match of both topic or content data and geospatial data with the pre-registered subscriptions.

6. A method as claimed in claim 1, wherein the messages are routed through the network based on a match of the extracted topic or content data with the pre-registered subscriptions, and the geospatial data associated with the pre-registered subscriptions is applied as a filter at an egress router to inhibit delivery of messages to topic or content matching subscriptions when the geospatial data in the messages does not match the subscription.

7. A method as claimed in claim 1, wherein the network comprises a single server with the subscribers connected thereto in a hub and spoke model.

8. A method as claimed in claim 1, wherein the network comprises a plurality of distributed routers, each forwarding messages at least in part on the basis of topic or content matching.

9. A method as claimed in claim 8, wherein the geospatial data associated with the pre-registered subscriptions is distributed throughout the network, and wherein individual routers within the network route incoming messages to other routers in the network based on a comparison of the topic or content data and geospatial data.

10. A method as claimed in claim 9, wherein the comparison of the extracted geospatial data with the geospatial data associated with said preregistered subscriptions is only performed on messages for which a match of the topic or content data with the corresponding data in the pre-registered subscriptions has occurred.

11. A method as claimed in claim 9, wherein the geospatial matching is performed using the XPATH language with an additional function to match geospatial data.

12. A method as claimed in claim 9, wherein the geospatial data is included in a message topic string associated with the messages and separate from the message body and wherein the routers extract the geospatial data from the topic string.

13. A method as claimed in claim 9, wherein each content router includes a subscription matching engine for matching extracted topic or content data with the corresponding data associated with said subscriptions and a separate geospatial matching engine for performing geospatial matching.

14. A content routed network wherein the messages are published into the network by publishers and routed to interested subscribers in accordance with their topic or content based on pre-registered subscriptions, comprising:
at least one router for distributing incoming messages to subscribers;
a memory for storing geospatial data in association with said subscriptions, said geospatial data defining by geographic coordinates an arbitrary geographic region of interest to a corresponding subscriber;
a subscription matching engine for comparing the topic or content data of said published messages with the pre-registered subscriptions;
a geospatial data processing unit for comparing the geospatial data from the published messages with the geospatial data associated with said subscriptions; and
wherein said at least one router is configured to deliver said messages to the interested subscribers based on the comparison of the extracted topic or content data and the extracted geospatial data with the corresponding data associated with said subscriptions.

15. A content routed network as claimed in claim 14, wherein the at least one router is configured to deliver the messages in the event of a match between the extracted topic or content data and the geospatial data with the corresponding data associated with the subscriptions.

16. A content routed network as claimed in claim 14, wherein the at least one router is configured to deliver the messages in the event of a partial match between the extracted topic or content and the geospatial data with the corresponding data associated with said subscriptions.

17. A content routed network as claimed in claim 14, wherein said geographic data define polygons identifying the geographic regions of interest.

18. A content routed network as claimed in claim 14, wherein the at least one router is configured to route messages through the network based on a match of both topic or content data and geospatial with the pre-registered subscriptions.

19. A content routed network as claimed in claim 14, wherein the at least one router is configured to route the messages through the network based on a match of the extracted topic or content data with the pre-registered subscriptions, and to apply the geospatial data associated with the pre-registered subscriptions as a filter to inhibit delivery of messages to topic or content matching subscriptions at an egress router when the geospatial data in the messages does not match the subscription.

20. A content routed network as claimed in claim 14, comprising a single server with the subscribers connected thereto in a hub and spoke model.

21. A content routed network as claimed in claim 14, comprising a plurality of distributed routers, each configured to forward messages at least in part of the basis of content matching.

22. A content routed network as claimed in claim 21, wherein the geospatial data associated with the pre-registered subscriptions is distributed throughout the network, and wherein individual routers within the network are configured to route incoming messages to other routers in the network based on a comparison of the content data and geospatial data.

23. A content routed network as claimed in claim 22, wherein the at least one router is configured to compare the extracted geospatial data with the geospatial data associated with said preregistered subscriptions only in respect of messages for which a match of the topic or content data with the corresponding data in the pre-registered subscriptions has occurred.

24. A content routed network as claimed in claim 21, wherein the at least one router performs geospatial matching using the XPATH language with an additional function to match geospatial data.

25. A router for use in a content routed network wherein messages are published into the network by publishers and routed to interested subscribers in accordance with their topic or content based on pre-registered subscriptions, comprising:
a memory for storing geospatial data defining by geographic coordinates an arbitrary geographic region of interest to a corresponding subscriber, said geospatial data being associated with the corresponding subscriptions;
a subscription matching engine for comparing topic or content data extracted from incoming messages with topic or content data associated with the subscriptions;
a geospatial matching engine for comparing geospatial data contained in incoming messages with geospatial data associated with pre-registered subscriptions; and
wherein said router is configured to forward said incoming messages based on the comparison of the extracted topic or content data and the extracted geospatial data with the corresponding data associated with said pre-registered subscriptions.

26. A router as claimed in claim 25, wherein said subscription matching engine and said geospatial matching engine are constituted by the same hardware.

27. A router as claimed in claim 25, further comprising a routing table containing data pertaining to the routing of messages in accordance with content and said pre-registered subscriptions distributed throughout the network.

28. A router as claimed in claim 25, wherein said geospatial matching engine is configured to function as a filter to control the delivery of messages to subscribers with matching content.

29. A router as claimed in claim 25, which is configured to route messages through the based on the comparison of both the topic or content and geospatial data, whereby messages are not forwarded through the network unless there is a match of both topic or content and geospatial data.

30. A router as claimed in claim 25, which uses a modified XPATH language to route messages, and wherein said modified XPATH language contains an additional function for carrying geospatial data.

31. A router as claimed in claim 25, which is configured to extract said geospatial data from metadata associated with said messages.
